(19) United States
(12) Patent Application Publication
(10) Pub. No.: US 2011/0311321 A1
(43) Pub. Date: Dec. 22, 2011

(54) Hydraulic solid transportation system

(76) Inventor: Roger Lynn Trueman, Mansfield (GB)

(21) Appl. No.: 13/135,522

(22) Filed: Jul. 8, 2011

Related U.S. Application Data
(63) Continuation of application No. PCT/GB2010/001179, filed on Jun. 16, 2010.

(51) Int. Cl. B65G 53/30

(52) U.S. Cl. 406/146

(57) ABSTRACT

A hydraulic solid transportation system suitable for the transportation of coal particulates from a mine said system comprising:
a pump;
a down pipe;
at least one hopper;
an up pipe;

wherein said pump pumps fluid down said down pipe; and

formation of a particulate-fluid suspension occurs in said hopper; and

by means of fluid pressure, said fluid purges the particulates from the hopper and along said up pipe;

said up pipe and down pipe connected by at least one cross pipe for inducing a fluid pressure change in said up pipe.

### FIELD OF THE INVENTION

The present invention relates to the extraction of solids by hydraulic means.

### BACKGROUND TO THE INVENTION

Manufacturers have previously made efforts to transmit solids, for example coal particulates over various distances and for various purposes. One particular field in which the transportation of solid particulates over a very large distance is fundamental, is in relation to mining, and in particular, coal mining. Coal mining for coal, is a huge industry. Coal is commonly generated into energy which can then be converted to, among other things, electricity. Coal mining requires the extraction of coal from underground or surface mines and the transportation of the coal thereof from the mines to be refined. The present invention is most relevant to underground coal mining. Underground coal mining and deep coal mining, usually requires mining at depths of 100 metres to 2000 metres. During underground and deep coal mining processes, coal particulates from the mine are required to be transported from mine shafts to the surface.

A present method used for the transmittal and transportation of coal from a mine shaft to the surface, includes a rope winder system. This system is widely used in many and various forms throughout the deep mining industry world wide. The technique has also been used in the construction industries.

A rope winding mechanism consists of two large, heavy skips or cages. These are bound by ropes to form a pulley mechanism. In general, two skips or cages are used in tandem so that as one skip is loaded with coal at the bottom of the mine shaft, a second skip is being emptied at the top of the mine. Once the skip at the bottom of the mine has been loaded, this skip is then wound up along the rope winder towards the surface of the mine whilst the unloaded skip is lowered down to the bottom of the shaft down the rope winder system. This method is a classic one up “one down continuous system”. This constitutes one cycle, The cycle is continuously repeated.

In order to achieve shaft capacity, i.e. to gain maximum efficiency of coal unloading and loading, in a common rope winder system, an acceleration and braking system is usually implemented in order to reduce the rope winder cycle time.

When the skips or cages are moving away from either the loading/unloading end points the pulley system is accelerated, however, as the skips are transported towards its end point for one cycle, the pulley system is then required to be braked.

This leads to inherent problems with the system. Firstly, the present rope winder mechanism requires a huge power generation which in turn creates a heavy demand on electricity in order to achieve a high shaft capacity. Furthermore, large sporadic demands for electricity are required in order to cope with the indicative nature of the system in terms of braking and acceleration. This process is hugely expensive, increasing the overhead costs of mining at any particular shaft, therefore, increasing the amount of coal required to be mined within a certain period in order to achieve a revenue over and above that of overhead costs. This can put heavy strain on this system. In order to increase cycle time, the rope winder system is accelerated. Large amounts of electricity is required in order to generate acceleration up to speeds which counter act gravitational pull. However, every time the system is braked, the acceleration energy of the winding cycle is lost, therefore, power needs to be continuously generated after breaking. This is an extremely expensive process.

Due to the many variables of the rope winder system, a further problem is that the winding system requires manual operation and constant manual supervision. 24 hour monitoring of the system is required as the components of the system are liable to constant wear and tear. A primary source of wear is the ropes themselves. Due to the nature of the rope winding system, a knocking of skips against the shaft walls or by inter-skip knocking can cause the ropes securing the cages to tear or un-knot. In an extreme case, a tearing or unknotting of a rope in a winding system could cause a “bird cage” effect, whereby all the ropes securing any one skip loosen and release from the skip so that the skip will fall down the shaft. This provides for an extreme safety hazard of the rope winder process, to the workers mining the coal and to the workers monitoring the rope winder system.

In a typical mine shaft, there are usually located two shafts, a downcast and an up-cast. The two shafts relate to the ventilation mode whereby clean air will enter the mine via the downcast and air dust, gas and water vapour will be released from the mine into the earth's atmosphere via the up-cast. As a result, in current modes of solid transportation, systems cannot be installed in the up-cast due to the poor quality of ventilation.

As a result, there is a need for a system which is more cost and time efficient, energy efficient, safer, and provides for an automated or partially automated monitoring and control system. A further problem faced by this challenge is the fact that any one single mineshaft will be of different dimensions to that of another mineshaft. Therefore, an installation method and/or service system is required so that a transportation system can be tailored to any one mineshaft by means of easy installation and use of such a system.

Hydraulic systems have been disclosed for the process of hydraulically mining coal, that is the process of breaking and cutting coal from a mineshaft wall or base. For example, U.S. Pat. No. 4,094,549 discloses a method for hydraulically mining coal whereby an entry is driven upwardly through a panel of coal to a predetermined terminus and a fluming system, which slopes in the same direction as the entry, is installed in the entry. A monitor is positioned in the entry and a high-pressure jet of water from the monitor is employed to cut coal from the face area of the panel of coal. The cut and broken coal is then further broken with a jet of high pressure water from a second monitor positioned in the entry and located near the face area. The broken coal is then fed to-the fluming system and transported through the flume with the aid of gravity as-a-coal-water slurry.

Furthermore, U.S. Pat. No. 4,685,840 proposes a method of transporting large diameter solids, such as coal having a diameter of greater than one inch, preferably 8 to 12 inches, predicated on pipe diameter, in the form of a slurry through a pipe line. U.S. Pat. No. 4,685,840 further discloses a method comprising the step of placing large diameter solids in a vehicle and pumping it through a pipeline. The specific gravity of the vehicle is substantially equal to the specific gravity of the solids so that the coal remains in suspension with a wide range of pipeline velocities. A lubricant is added to the vehicle to reduce friction and enhance energy efficiency of the process. The coal is pumped from a pumping tank into which the solids and the vehicle are introduced, the pumping tank, after filling, is pressurized with a fluid such as air or inert gas to propel the mixture through the pipeline. This pump and its valving allow large diameter solids to be pumped through the pipeline. The large diameter of the solids reduces the apparent viscosity of slurry to greatly reduce friction and further enhance energy efficiency.

However, the cited prior art documents and methods outlined above, do not solve all of the problems discussed.

The present invention aims to solve all of the above mentioned problems, by way of a method for the transportation of coal or other said particles via a hydraulic system. In light of the matters discussed, there is an inherent need for a system for transporting coal from a mineshaft to the earths surface which relative to the shaft capacity requires minimal energy to run the system whilst also being time efficient. There is also a need for the system to be safe non-hazardous in relation to existing systems and to incorporate a fully or semi-automated monitoring and control means. Furthermore, there is required a monitoring system for the continual maintenance of the transportation system as well as the a simple installation method and procedure.

Furthermore, the present invention provides for a system that may be installed and implementing in any shaft of a mine regardless of the ventilation mode i.e. either in the downcast or the up-cast of a mine.

The present invention further aims to provide a system equipped to raise solid particulate from any base of a mineshaft upto the mine surface with the ability to be scaled up or down to meet the needs of each individual mineshaft cavity. The present invention has a significant advantage over those of straight-sided skips as disclosed in the prior art in that the present invention may be utilised more efficiently in mineshafts of varying shapes and sizes and particularly in mineshafts of a circular cavity where angular skips as disclosed in the prior art may struggle to operate. The present invention also aims to disclose a method of solid particulate transportation such that the cost of installation of such a hydraulic solid transportation system is significantly cheaper than that of conventional methods such as skip or conveyor systems and also aims to be further cost efficient in use due to the relative low power requirement of the system in operation. As mentioned previously, for conventional rope winding mechanisms, in order for this prior art mechanism to be efficient, it must achieve shaft capacity i.e. to gain maximum efficiency of coal unloading and loading. In order to do this, there is a highly expensive requirement of electrical power generation in order to generate acceleration during part of a rope winding cycle.

The present invention aims to remove the need for such a maximum demand/supply of electrical power therefore increasing the cost efficiency of the system. The present invention also aims to increase the efficiency of volume of raw coal supply transported from the base of a mineshaft to the mineshaft surface by providing a method of transporting even residual small solid particulates which can be recovered at the base of a mineshaft for use as coal.

The present invention also aims to solve the need for a solid transportation system whereby the system can be instantaneously configured to change the acceleration and therefore transportation to be of solid particulates at a plurality of points in the system for particulates removing from the mineshaft up to the mineshaft surface.

The hydraulic solid transportation system is a continuous operation of fluid pumpage and management thereof. An advantage of the system is such that solid particulates can be transported over long distances in a vertical direction with a continuous supply of fluid providing for a circulation system similar to that of the blood circulatory system in a human body.

### SUMMARY OF THE INVENTION

According to a first aspect there is provided a hydraulic solid transportation system suitable for the transportation of solid particulates from a mine, said system comprising:

at least one hopper suitable for forming a fluid-solid particulate suspension in said hopper;

a down pipe for transporting a fluid to said at least one hopper;
a pump for pumping fluid down said down pipe;
an up pipe for transporting said fluid-solid particulate suspension away from said at least one hopper;

characterised by:

a plurality of cross pipes, each extending between said down pipe and said up pipe, said plurality of cross pipes being positioned at a plurality of different heights; and wherein

a fluid pressure change may be induced in said up pipe at one or a plurality of different heights in said up pipe by transfer of pressure and/or fluid from said down pipe to said up pipe via one or more of said plurality of cross pipes.

According to a second aspect, there is provided a method of transporting solid particulates from a mine, said method comprising:

delivering a pressurized fluid to a hopper via a down pipe;

forming a fluid—solid particulate suspension in said hopper; and

transporting said fluid/solid particular suspension away from said hopper by an up pipe; and characterized by

creating a fluid pressure change in said up pipe at one or a plurality of different heights along said up pipe, by transferred pressure and/or fluid from said down pipe to said up pipe via a plurality of cross pipes positioned at a plurality of different heights along said up pipe.

Other aspects are as recited in the claims herein.

### BRIEF DESCRIPTION OF THE DRAWINGS

For a better understanding of the invention and to show how the same may be carried into effect, there will now be described by way of example only, specific embodiments, methods and processing according to the present invention with reference to the accompanying drawings in which:

FIG. 1 shows an overview of the hydraulic transportation system in accordance with an embodiment of the present invention.

FIG. 2 shows an embodiment of the present invention including a view of the water recycle circuit.

FIG. 2A shows a birds eye view of a mine shaft to compare the dimensions of the present invention with existing rope winder systems.

FIG. 3 shows an embodiment of the present invention.

FIG. 4 shows a section of the vertical piping network of an embodiment of the present invention.

FIG. 4A shows a birds eye view of the cradle installation system of an embodiment of the present invention.

FIG. 5 shows a section of the piping network of an embodiment of the present invention.

FIG. 6 shows a dual pressure hopper system in an embodiment of the present invention.

FIG. 7 shows an inclined flush hopper system in a preferred embodiment of the present invention.

FIG. 8 shows the dual pressure hopper system in a preferred embodiment of the present invention.

FIG. 9 shows a graph outlining the coal output in relation to the flow rate of the hydraulic solid transportation system.

FIG. 10 shows a cradle installation method in a preferred embodiment of the present invention.

FIG. 11 shows a view of a solid particulate separation apparatus according to a preferred embodiment of the present invention.

FIG. 12 shows a solid particulate separation apparatus according to a preferred embodiment of the present invention.

FIG. 13 shows a close-up front view of a solid particulate separation apparatus according to a preferred embodiment of the present invention.

FIG. 14 shows a close-up side view of a solid particulate separation apparatus according to a preferred embodiment of the present invention.

FIG. 15 shows a close up view of a section of the hydraulic solid transportation system according to a preferred embodiment of the present invention.

FIG. 16 shows a cross section of coal/water separation apparatus according to a preferred embodiment of the present invention.

FIG. 17 shows a side view of a hopper injector with an air/gas purge apparatus according to a preferred embodiment of the present invention.

FIG. 18 shows a side view of an inclined low pressure cylindrical lateral storage slide hopper according to a preferred embodiment of the present invention.

FIG. 19 shows a hydraulic solid transportation system in preferred embodiment of the present invention.

FIG. 20 shows a front view of an up pipe cleansing system in accordance with a preferred embodiment of the proposed invention.

FIG. 21 shows a view of a hydraulic solid transportation system at the entrance of the mine shaft in accordance with a preferred embodiment on the present invention.

FIG. 22 is a birds eye view of the hydraulic solid transportation system in accordance with a preferred embodiment of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well-known methods and structures have not been described so as not to unnecessarily obscure the description.

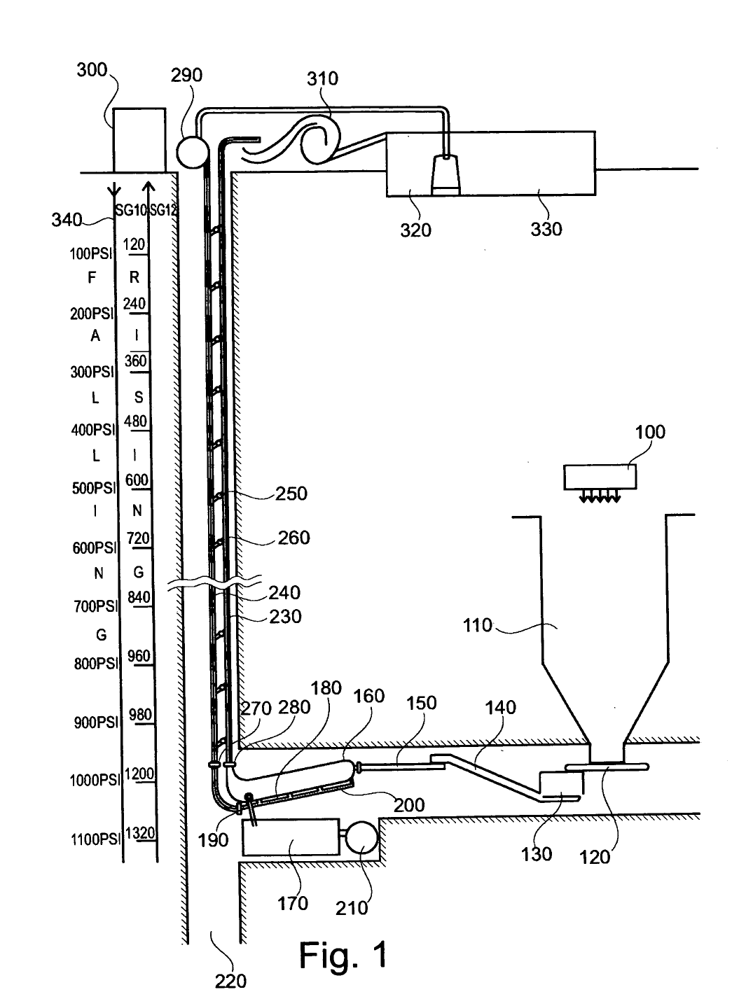

FIG. 1 comprises primary breaker 100; hopper 110; slow scalp belt feeder 120; sizer 130; chain conveyor 140; screw conveyor 150; pressure hopper 160; drain holding tank 170; vortex scour injector 180; drain 190; scour jets 200; high pressure pump injector 210; sump 220; up-pipe 230; down-pipe 240; cross pipe 250; cross pipe valves 260; throttle valves 270; throttle valve 280; pump one 280; pump two with diesel standby 300; two stage cyclone 310; primer agitator pump 320; black water reservoir 330; and pressure variation chart 340.

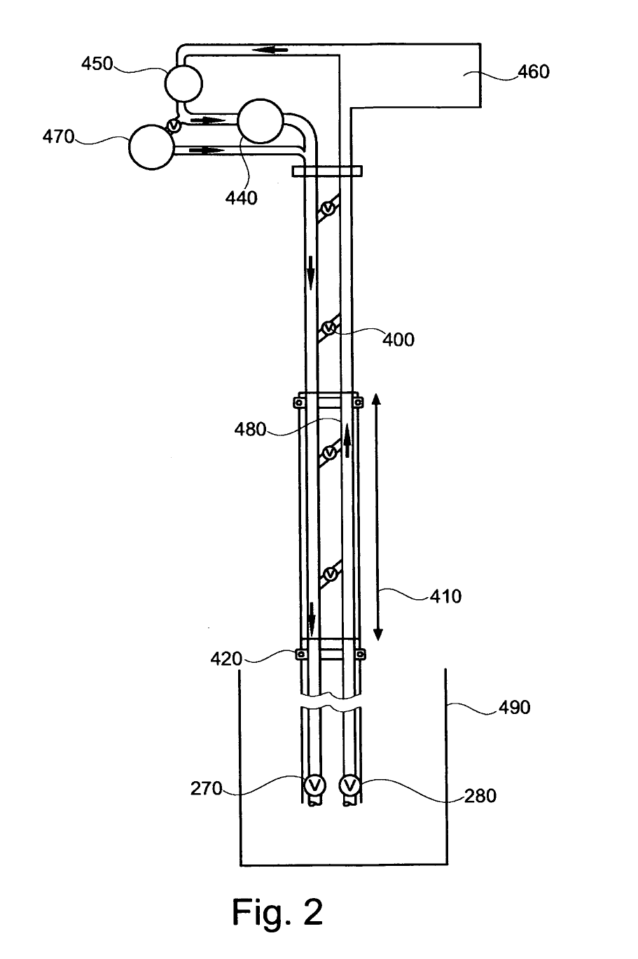

FIG. 2 comprises vortex inducers 400; incremental pipe and frame section 410; pipe system anchorage means 420; throttle valve 270; throttle valve 280; high range pump 440; primer 450; dewater and preparation system 460; diesel power pump 470; recycle water circuit 480; and sump 490.

FIG. 2A shows cradle 1500; shaft wall 1510; and skip compartments 1520.

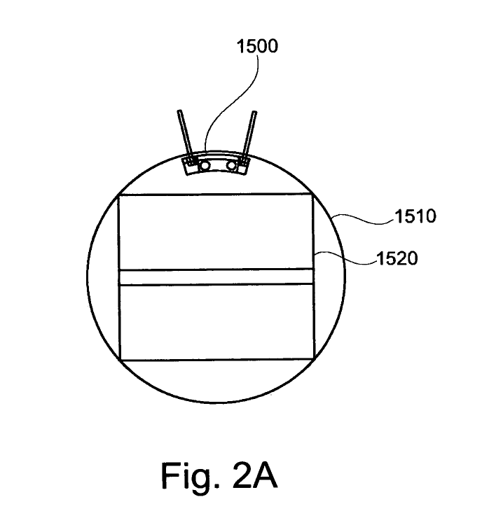

FIG. 3 shows vortex scour injectors 500; control valve 510; and control valve 520.

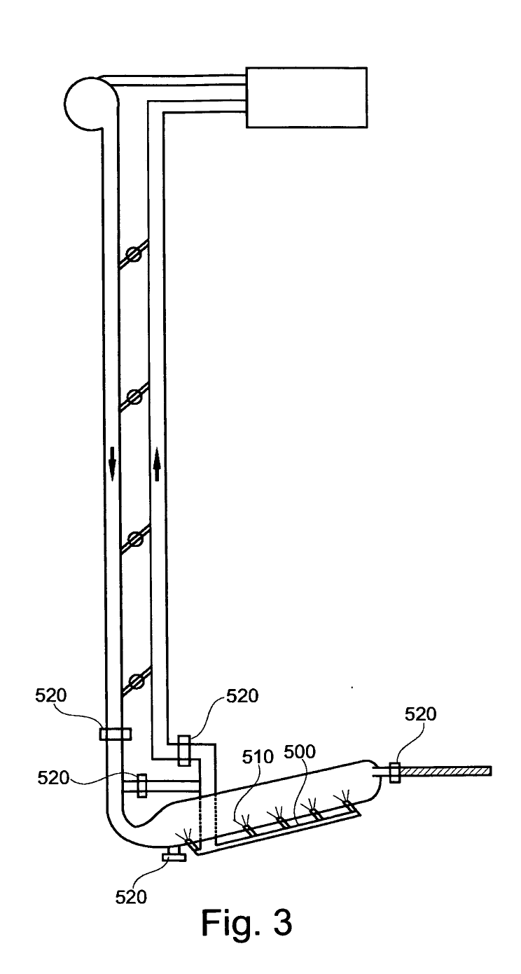

FIG. 4 shows incremental pipe 600; cross pipe 610; heavy side bolting and cradle 620; spine girder 630; and direction of flow 640.

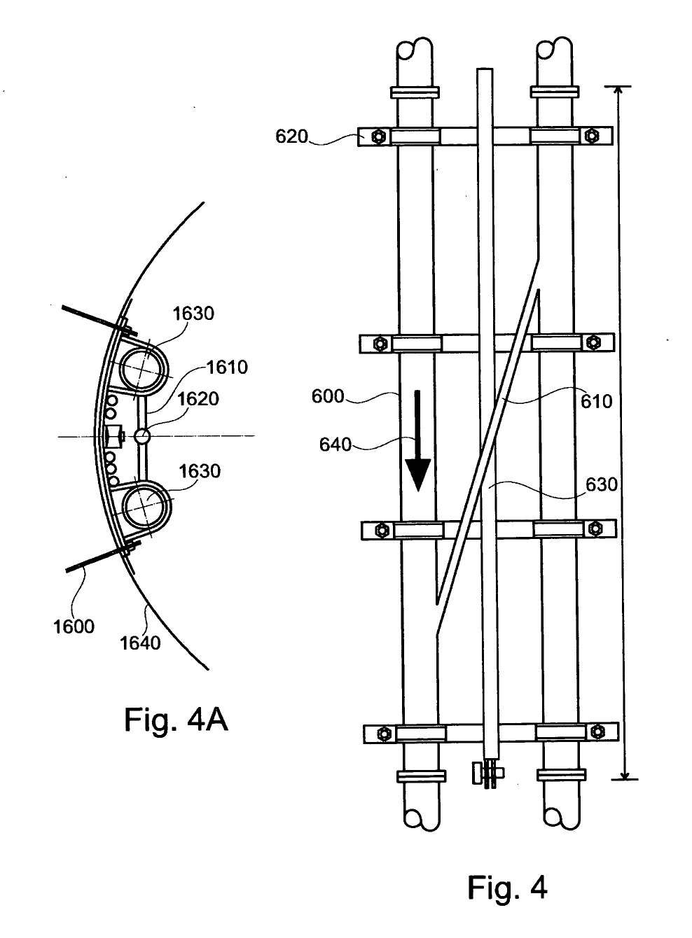

FIG. 5 shows incremental pipe section 700; cross pipe 710; vortex inducer 730; and spine girder hook 740.

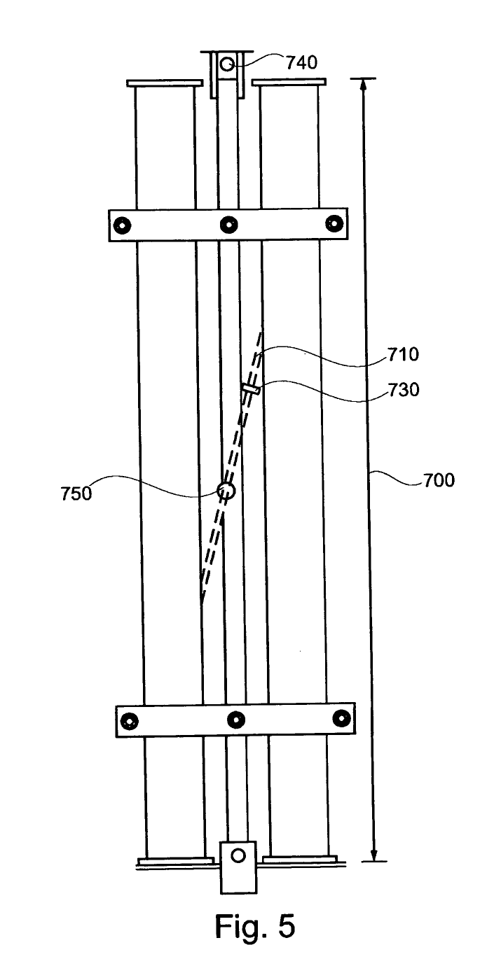

FIG. 6 shows dual pressure hopper 800; breather and breather valve 810; breather and breather valve 820; screw conveyor 830; fast screw solids filler 840; down-pipe 850; up-pipe 860; regulator valve 870; valve 880; valve 890; flow regulated by bypass 900; first hopper 910; second hopper 820; vortex scour injector 930; vortex scour injector 940; control valve 950; and control valve 960.

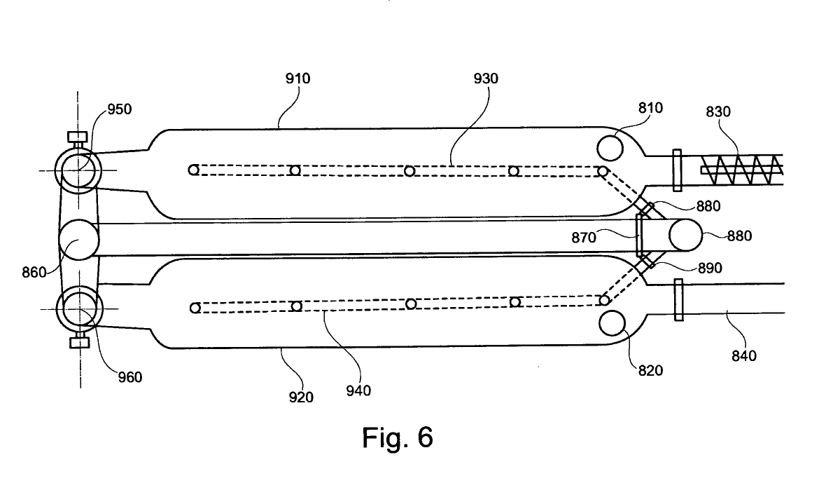

FIG. 7 shows inclined flush hopper 1000; breather and breather valve 1010; screw conveyor 1020; screw conveyor valve 1030; down pipe 1040; valve 1050; emergency drain sump 1060; scour jets 1070; scour valves 1080; vortex scour injector 1090; drain 1100; drain pipe 1110; up pipe 1120; and valve 1130.

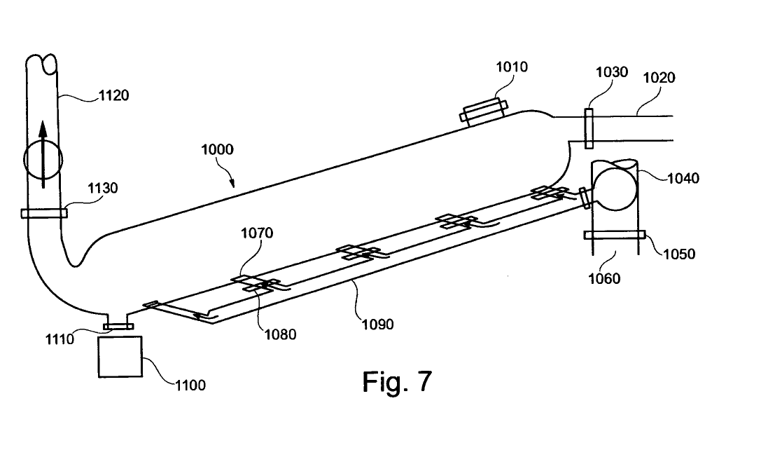

FIG. 8 shows dual pressure hoppers 1200; control valve 1210; vortex scour injector 1220; vortex scour injector 1230; cross pipe 1240; multi-section construction 1250; up-pipe 1260; down-pipe 1270; regulator valves 1280; breather and breather valve 1290; breather and breather valve 1300; screw conveyor valves 1310; and regulator valves 1320.

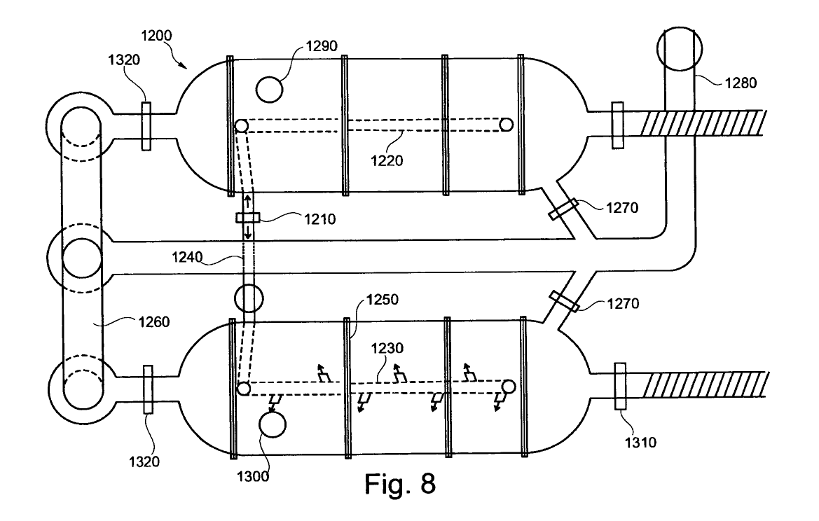

FIG. 9 shows a graph showing ratio of speed of flow of hydraulic solids transportation system in ratio to the amount of coal produced from a mineshaft (in millions of tons).

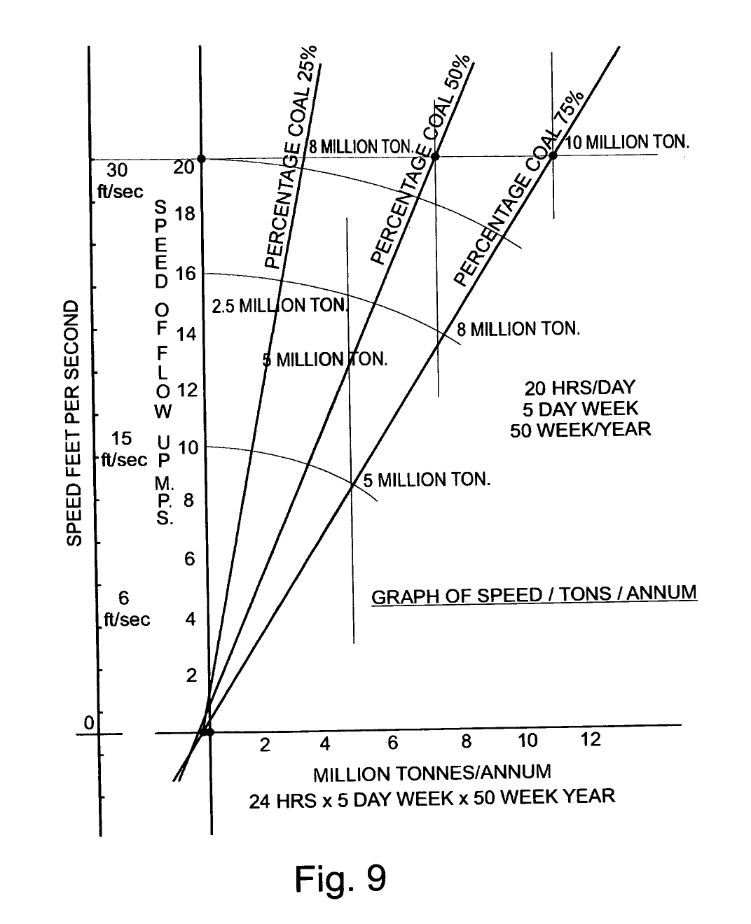

FIG. 10 shows cradle 1400; tell-tale bolts 1410; monitor lines 1420; cables 1430; air compression 1440; and hydraulic pressure regulators 1450.

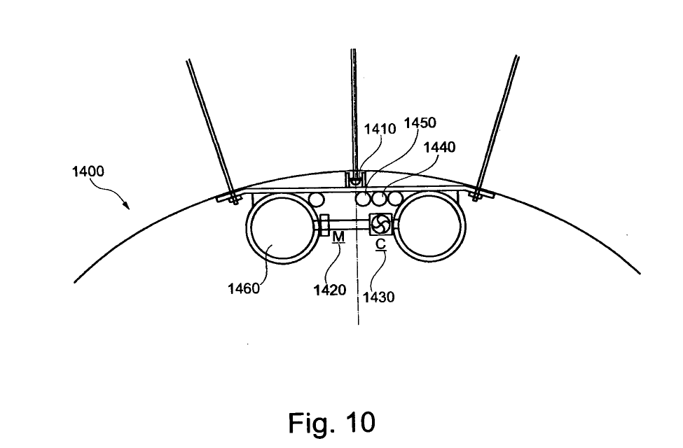

FIG. 11 show up pipe 1500; expresser pipe 1510; cyclone and re-circulation exits point 1520; solid de-water reduction chamber 1530; sieve plate 1540; sieved fluid chamber 1550; and solid particulate un-loader 1560.

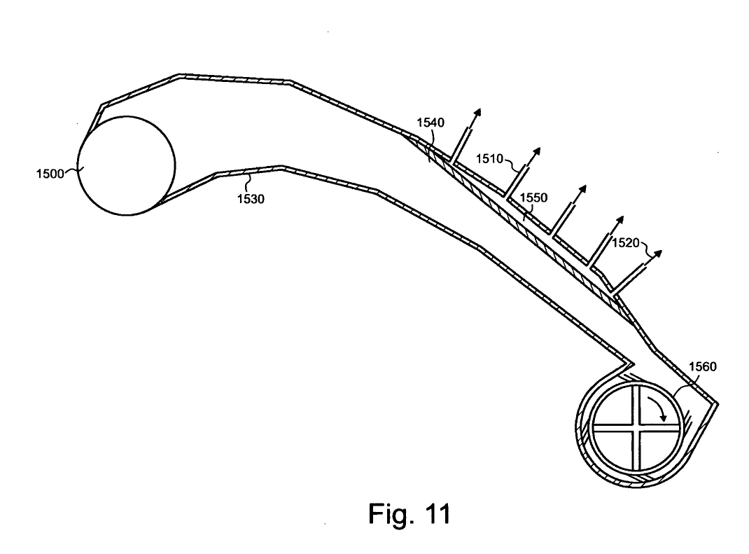

FIG. 12 shows de-blinding jets 1600; transportation pipe 1610; solid de-water reduction chamber cross section 1620; solid de-water reduction chamber cross section 1630; and solid particulate water slurry flow direction 1640.

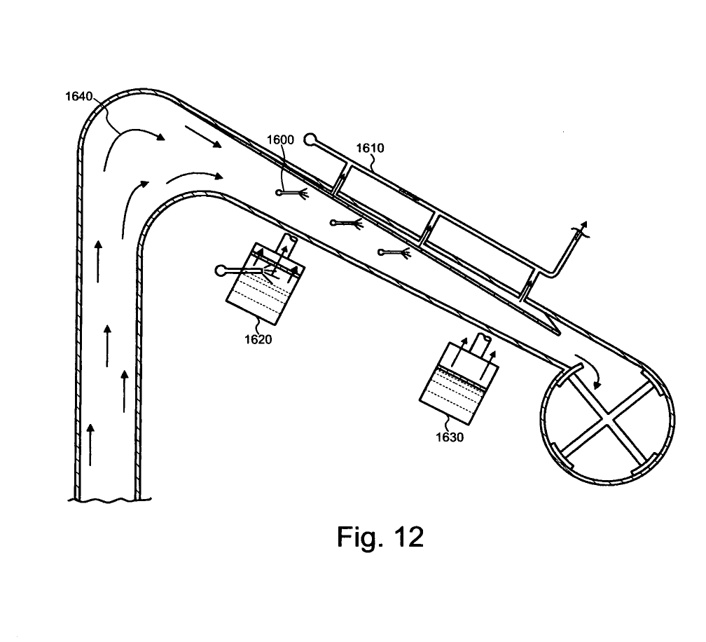

FIG. 13 shows rotating drum axle 1700; solid particulate directional flow 1710; drum 1720; and solid particulate exit point 1730.

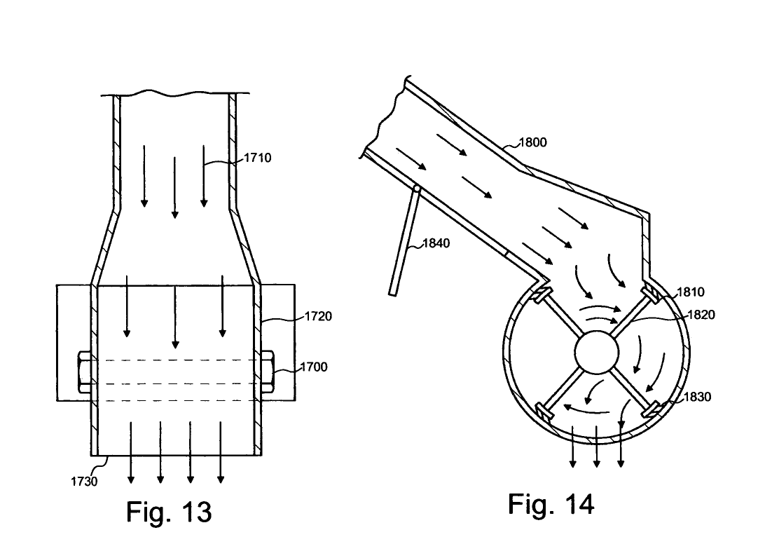

FIG. 14 shows solid de-water reduction chamber exit 1800; rotating drum 1810; rotating drum valve 1820; seal 1830; and escape hatch 1840.

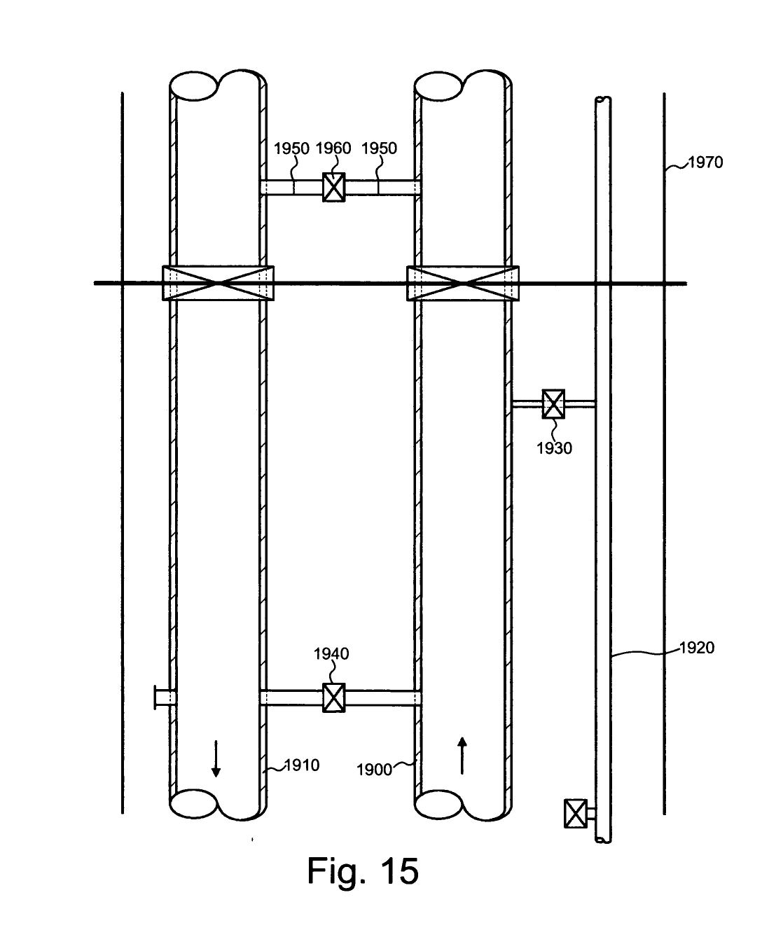

FIG. 15 shows up pipe 1900; down pipe 1910; high pressure pipe 1920; cross pipe 1930; cross pipe 1940; manual valve 1950; automatic valve 1960; and mounting frame 1970.

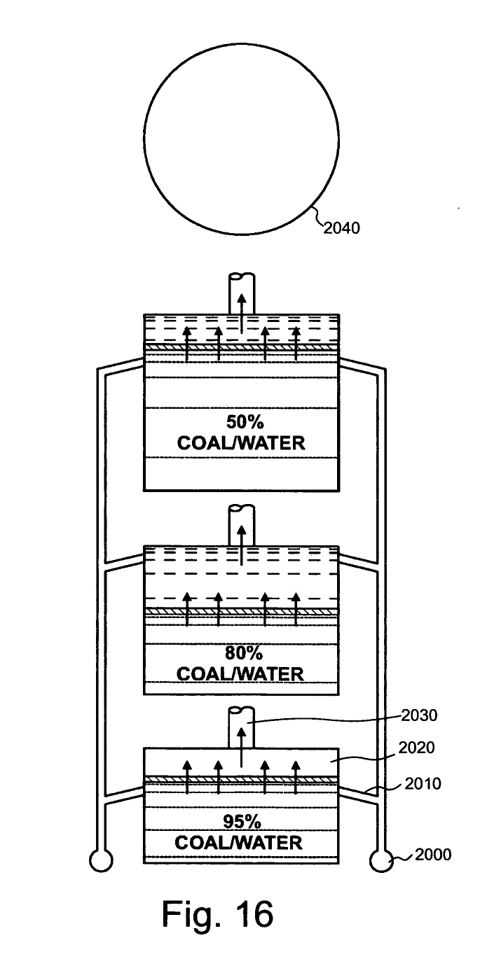

FIG. 16 shows clean water supply 2000; water de-blinding jet 2010; sieve plate 2020; connector pipe 2030; and expresser pipe 2040.

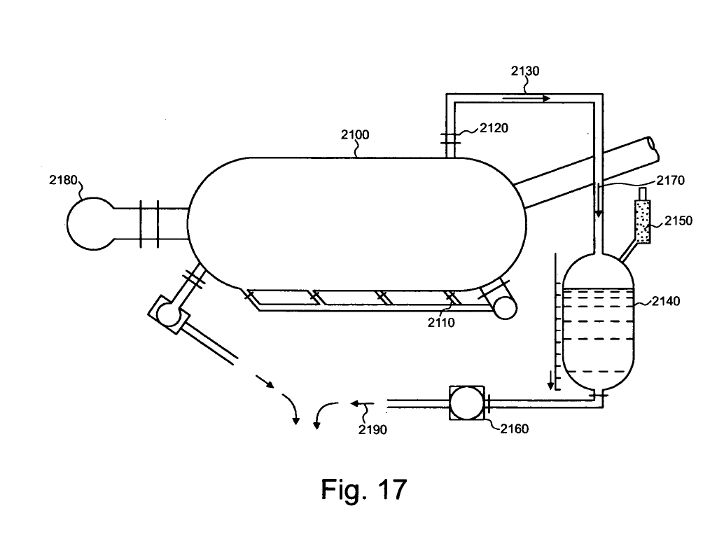

FIG. 17 shows hopper injector 2100; injector jets 2110; breather valve 2120; purge line 2130; receiver tank 2140; diffuser 2150; suction pump 2160; air flow direction 2170; up pipe entrance 2180; and water flow to holding tank 2190.

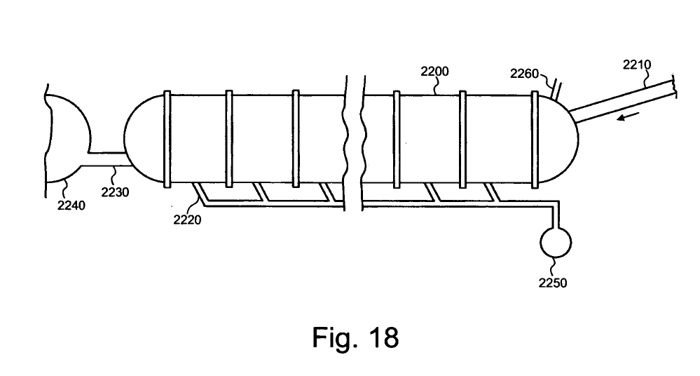

FIG. 18 shows a low pressure cylindrical slide hopper 2200; solid particulate input 2210; slide hopper water jets 2220; slide hopper output 2230; additional series hopper bunker 2240; hopper water supply 2250; and breather valve 2260.

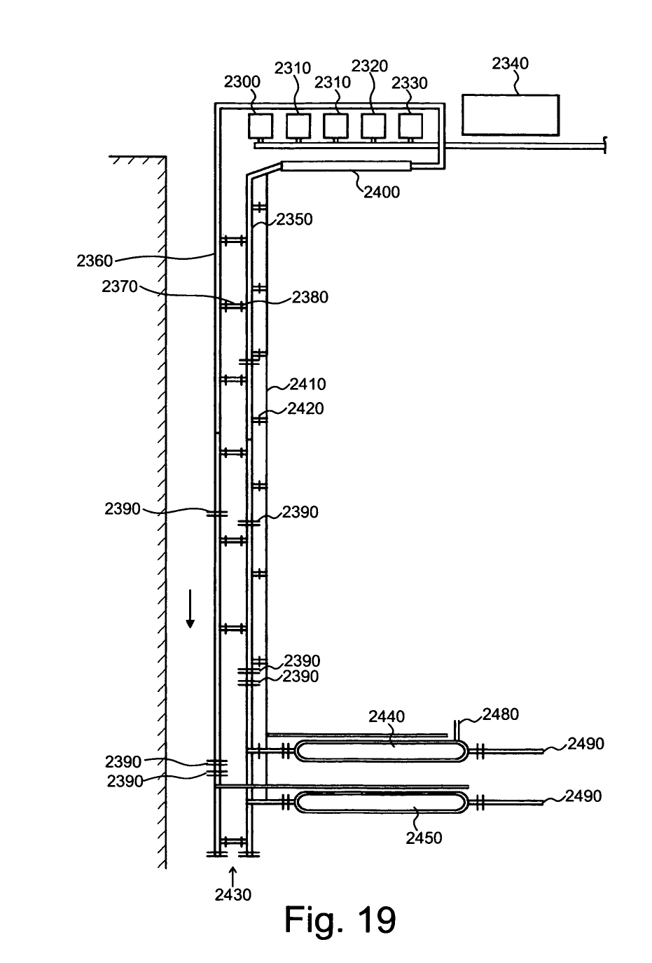

FIG. 19 shows pump 2300; reserve pumps 2310; high pressure pump 2320; hydraulic pump 2330; generator 2340; up pipe 2350; down pipe 2360; cross pipe 2370; valve 2380; isolation valves 2390; filtration sieve 2400; high pressure pipe 2410; punch injectors 2420; sump 2430; pressure hopper 2440; pressure hopper 2470; breather pipe 2480; and coal particulate input line 2490.

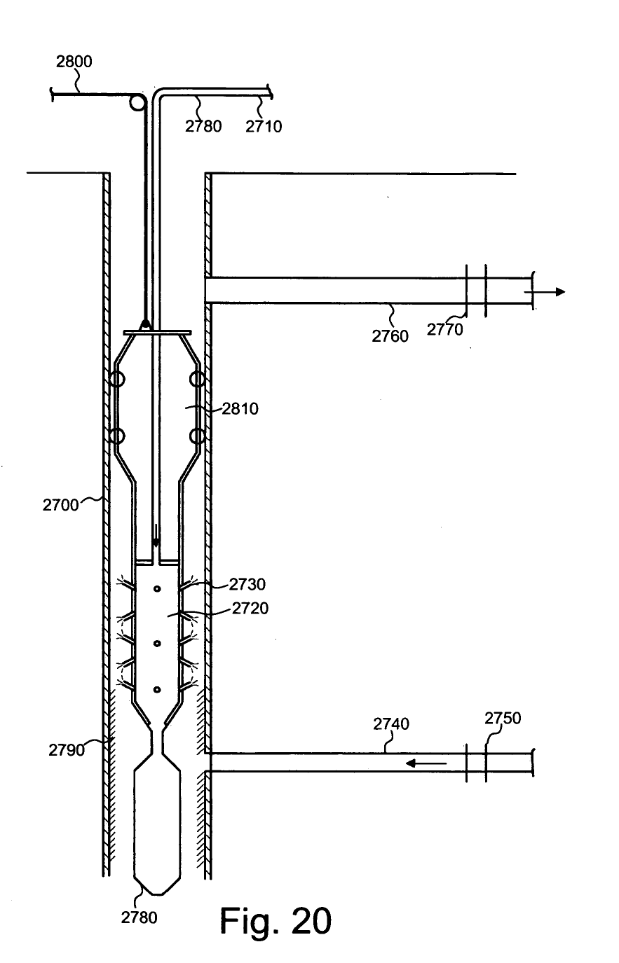

FIG. 20 shows up pipe 2700; high pressure cleaning pump 2710; jet tank 2720; high pressure jets 2730; high pressure cross pipe 2740; valve 2750; medium pressed cross pipe 2760; valve 2770; high pressure hose winder 2770; heavy weight 2780; scaling of solid particulates of solid particulates on internal surface of up pipe 2790 spring loaded central stabilizer 2810; and haul rope winder 2800.

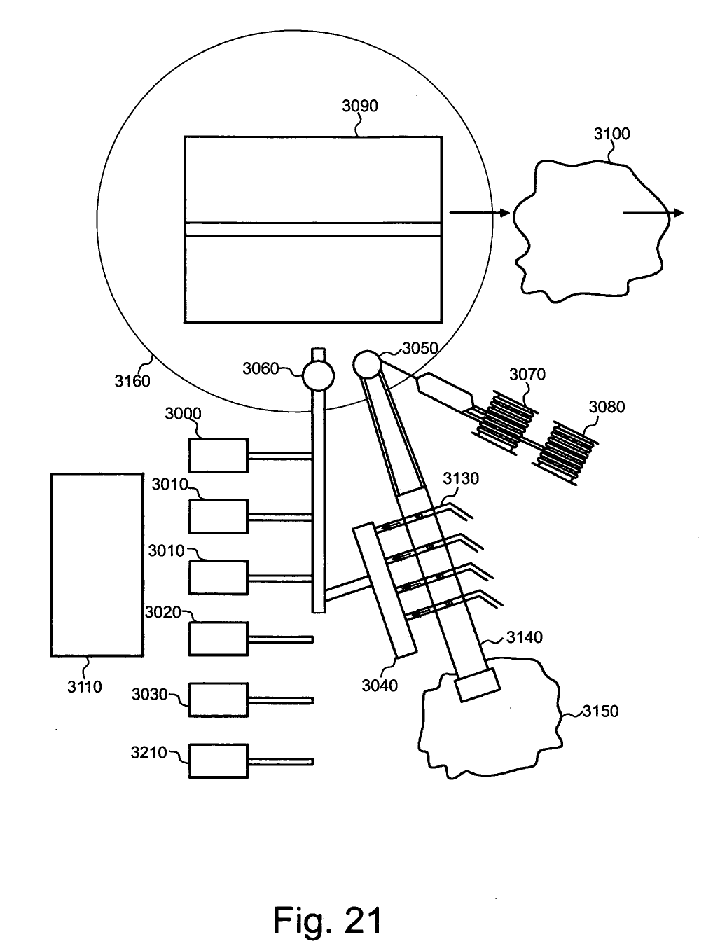

FIG. 21 shows main pump 3000; back up pumps 3010; hydraulic pump 3020; high impact pulse pump 3030; expressed water manifold 3040; up pipe entrance 3050; down pipe entrance 3060; high pressure hose winder 3070; haul rope winder 3080; skip cage collector 3090; skip discharger 3100; auxiliary power supply 3110; compressed air source 3120; sieve plates 3130; solid de-water reduction chamber 3140; and solid particulate collector 3150.

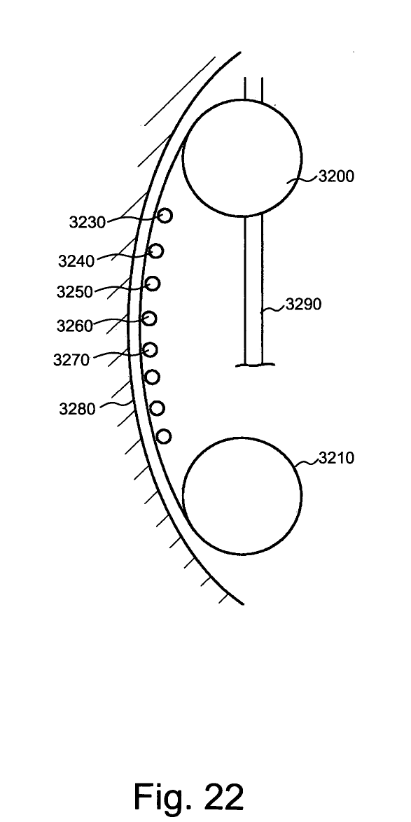

FIG. 22 shows up pipe 3200; down pipe 3210; CCTV/control microphone 3230; hydraulic pump 3240; compressed air source 3250; power cable 3260; monitor 3270; mine shaft edge 3280; and cross pipe 3290.

Preferably, the water used in operation of the hydraulic solid transportation system will be stagnant or deoxygenated water to prevent the build up of gas bubbles which would result in a water hammer effect (pressure surge).

Referring to FIG. 1 herein, there is shown a primary breather 100. The primary breaker is a generic system and method for removing, drilling and/or breaking coal from the interior of a mineshaft. Once the coal has been extracted from the walls, ceiling or floor of the mineshaft, coal particulates of various sizes, are transferred to a hopper 110. Preferably the sizer sizes the particulate to between 0 mm to 100 mm. Hoppers for this principle use can usually support approximate 350 tonnes of coal. At the hopper mouth, coal particulates are then transferred onto a slow scalp belt feeder 120 in which the particulates are then transported to a sizer 130. A sizer is designed for primary or secondary sizing of coals, industrial minerals and ores. Sizers are generally seen as extremely rugged and utilize sizing rotors in a variety of tooth patterns which can size solids to an appropriate size. A sizer usually further comprises a crushing chamber.

In a preferred embodiment the pressure hopper will be able to withstand high pressure, for example 1000 pounds per square inch (psi) at depths of 1000 metres. Mine shafts are normally at depths of approximately 500 m.

For the purposes of the present invention, sizer 130 would likely size coal particles into sizes between 0 mm to 15 mm in diameter, however alternatively various sizes could be used as to break coal particles into sizes outside of this range.

Chain conveyor 140 is shown to transport coal from sizer 130 to screw conveyor 150. A chain conveyor generally comprises interlocking metal links which is motorized to form a transport belt on which solids can be transported from one area to another. A screw conveyor is usually in the form of a rotary screw on which solids are placed on the thread of the screw and can be transported via rotation to the “point” end of the screw. Screw conveyor 150 will transport coal particulates which have been sized in sizer 130 to a pressure hopper 160 or plurality of hoppers. Screw conveyor 150 allows for easy access of coal particulates to said hopper 160 or plurality of hoppers.

It should be noted that after the stage of extraction of coal using primary breaker 100, that trampirons and other unsuitable materials including ores and other minerals would generally be removed from the crude coal solids with the utilization of well-known methods and processes, for example the use of magnets.

Furthermore, it should also be known that sizer 130 may comprise a machine or bank of machines which are suitable to prepare coal particulates for the injection and transmittal through the hydraulic solid transportation system. In a preferred embodiment, the crushing sizer machine will be operated in a fluid bath or in the presence of a high moisture content in order to eliminate any hazard risk. This is due to the coal dust in a dry atmosphere giving rise to highly combustible conditions. Due to the strict grading requirements of the hydraulic solid transportation system, re-circulation of oversized coal particulates may be required. The screw conveyor 150 may be similar to those used on large circulatory tunneling machines. However, various other feeding systems for injecting pressure hopper vessels 160 with solids may be used, for example by a compressed air system, by simple gravity feed, or via a slurry pump whereby the said slurry pump is connected directly to the pressure hopper 160 via a valved pipe which could be filled from any point of the vessel regardless of capacity. It is important to note however that any such feed must be capable of supply of coal particulates on a scale as to meet the demands of the mine shaft capacity and allow maximum efficiency of the hydraulic solids transportation system.

In FIG. 1, in accordance with one embodiment of the present invention, coal particulates will be transported from the screw conveyor 150 into pressure hopper 160. The screw conveyor valve will then be closed. Water from down-pipe 240 will then be injected into hopper 160 via means of scour jets 200 in order to form a suspension of coal particles in water. The injection of water into the pressure hopper will cause the purging of the coal-water slurry up up-pipe 230 upon control of throttle valve 280. The velocity of pumping will be controlled via throttle valves 270 and 280 which may be in the form of a control valves in which the valves can be opened or closed to incremental hole diameters in order to increase or decrease water pressure.

Between up-pipe 230 and down-pipe 240 are cross pipes 250 which, in a preferred embodiment are located at incremental heights along the up-pipe/down-pipe system. In a preferred embodiment the cross pipes will be substantially angled at 45° in an upwardly direction from the down-pipe end to the up-pipe end to the cross pipe. The cross pipes 250 allow for fluid to be transferred from down pipe 240 to up pipe 230.

The cross pipes incorporate a pumping means for increasing the flow rate of the coal-water slurry travelling up the up-pipe 230. The actuated force of the pumping means will be controlled via control valves 260 located substantially on each and every cross pipe. The location of cross pipes at incremental heights of the up-pipe/down-pipe piping system will allow movement and transportation of the coal-water slurry up the up-pipe 230 to be locally controlled. For example, if there was a blockage at a height of 100 metres, or a slow in flow rate at this height, then a cross pipe pump located directly beneath this level would be able to induce and increase the flow rate of the coal-water slurry directly above it in order to remedy the blockage or to increase the flow rate at that particular section.

Furthermore, each and every cross pipe in a preferred embodiment will be fitted with a vortex inducer 400. Vortex inducers in an embodiment of the present invention will act to create a vortex in the up-pipe to increase the flow of the coal-water slurry up the up-pipe 230.

Vortex can be described as any flow possessing water velocity, for example an eddy, whirlpool or other rotary motions.

In other embodiments, vortex inducers may by implemented to induce a vortex in other parts of the hydraulic solid transportation system.

The cross pipes 250 have various advantages. The cross pipes 250 may act as an accelerator to the upward flow of the coal water slurry up the up-pipe 230.

Furthermore, the cross pipes create turbulence in the upper pipe 230. The turbulence acts to orientate particles in the coal water slurry in a non-streamline fashion. Due to this, the chaotic flow of a coal water slurry following turbulence created by cross pipes 250, enhances the flow rate of the coal water slurry up the up-pipe 230.

The up-pipe 230 and down-pipe 240 may be of differing diameter size. In turn, the resultant pressure of the coal water slurry in the up-pipe and down-pipe will be different. Due to the differing internal pressure of the up-pipe and the down-pipe in a specific embodiment, the cross-pipe 250 may be utilized to alter pressure in the up-pipe or down-pipe by opening or closing the cross-pipe valves, thus releasing or increasing the pressure of the up-pipe, dependant on the size of the up-pipe relative to the down-pipe.

In a specific embodiment of the present invention, the cross-pipes will be located incrementally at varying heights linking the up-pipe and down-pipe. Due to this, in the event of a pipe clogging at a certain height, the flow of the coal water slurry may be continued or restored above the blockage by opening of the incremental cross-pipe above said blockage. Additionally, systematic operating of the cross-pipes may also be utilized to rescue or clear the area of the pipe which is blocked. A particular method may be to sequentially operate the cross pipes one by one starting at first from the top located cross-pipe progressing to the bottom cross-pipe in numerical order in order to systematically clear a blocked pipe.

The cross pipes may be positioned at between 10 to 30 metre increments along a vertical axis between linking the up pipe and down pipe.

The cross pipes may be functioned with or in the absence of the vortex inducing means by manipulation of the cross pipe valves.

Therefore, the cross-pipes may also be utilized to rescue a blocked pipe situation, therefore restoring the operation status of the up-pipe by means of incremental blockage release. The cross-pipe may be applied to unblock one or a plurality of blockages individually or concurrently.

The action of the cross-pipe to create turbulence denies the streamlining tendency of solid particulates in the coal-water slurry thus resisting fallback by gravity. By exposing the flatter faces of the solid particulates to the upstream of the coal-water, this attracts more force of flow of solid particulates up the up-pipe.

In a specific embodiment of the present invention, an additional down-pipe may be introduced designed to be linked to the primary up-pipe via a single or plurality of cross-pipes to deliver a short low-volume high-energy pulse of energy via separate system, thus providing an injection of energy into the up-pipe portion of the hydraulic solid transportation system, therefore providing an additional mechanism to prevent the streamlining of solid particulates with a more measured and consistent control. The cross-pipes in the system have the additional advantage of being utilized to provide a high pressure clean water jet into the up-pipe system, thus providing a means to clean the up-pipe of solids which cling and scale to the up-pipe interior wall. This in turn will maintain a smooth conduit and therefore further increasing the flow rate and efficiency of hydraulic solid transportation.

In accordance with FIG. 1, pressure hopper 160 may include a drain 190 which links to a drain holding tank 170. Drain holding tank 170 may be attached to a high pressure pump injector 210 which is able to pump water back from the drain holding tank into the pressure hopper 160 allowing for a recycling of water and thus water efficiency. A draining of liquid in pressure hopper 160 into drain holding tank 170 will allow for coal particulates to re-enter the pressure hopper via screw conveyor 150.

Located substantially towards the surface mouth of the mine shaft will be pump one 290. Pump one is a standard generator, electricity or alternative energy source which will act to generate and increase as well as decrease the flow rate of the fluid in the transportation system. If there is a failure in pump one an automated or manual system will be in place in which pump two with a diesel standby 300 will come into effect so that pump two will take over the role of pump one in generating energy and therefore fluid pressure to increase the flow rate of the hydraulic transportation system.

The incremental pressure of fluid in the down-pipe will increase in proportion to the depth of the down-pipe beneath the earth's surface 340. For example, the internal pressure of the down-pipe when at the depth of between 10-20 metres from the mineshaft mouth is likely to be to the order of 100 psi.

However, further down the down-pipe at a depth which is much greater, the pressure increase may be equivalent to 1000 to 1200 psi. The difference in pressure provides for an advantage of locating first pump 290 and/or second pump 300 substantially near the top of said down-pipe 240.

The pressure changes in up-pipe 230 are likely to be of similar proportion of that of those in the down-pipe. However, the difference in pressure (in psi) is likely to be 1.0:1.2 between the down-pipe and up-pipe at any given depth.

Once the coal-water slurry exits up-pipe 230 at an exit located substantially towards the surface of a mineshaft, in accordance with an embodiment of the present invention the coal-water slurry will then filter through a two-stage cyclone system 310. The cyclone system acts to filter the impurities from the coal-water slurry. A black water reservoir 330 will prevail which will substantially consist of coal and water. A primer agitator pump 320 and various other separation techniques will then be used to separate the water from the coal particulates to provide for a crude coal product.

Vortex inducers 400 may further work to push or break coal particles which had not been suitable sized in sizer 130 or any other primary or secondary sizer which may lead to a fallback of coal particles. A fallback situation may occur if a coal particulate is too heavy or dense and the action of one pump is not sufficient to combat the act of gravity so that the coal particulate can not be pumped up the up-pipe to the system's exit. This provides a further advantage of the cross pipes 250 and vortex inducers 400 as this system can provide for an additional “boost” to pump any larger coal particulates up the up-pipe.

The down-pipe 240 is situated to provide fluid to the pressure hopper 160 for the purposes of purging the contents of solids by means of water pressure induced by the opening of the throttle valve 270.

The pressure hopper valves will then be closed when solids have been fully purged and the re-filling of solids is re-commenced. The up-pipe 230 will be positioned as to allow entry of solids from the depressurized hopper to the up-pipe.

The throttle valve 270 is fitted into the base of the down-pipe in order to raise the pressure to the down-pipe 240 thus increasing the differential pressures at each cross pipe 250 connection to the fluid in the up-pipe 230. This will give rise to the increase flow of the fluid in the up-pipe 230, thus again controlling any fallback.

In another embodiment of the present invention, pump one 290 will consist of two electrical high volume pumps (one main and one on standby), and pump two will consist of two diesel emergency high volume pumps. Both pump one 290 and pump two 300 will be able to vary the flow and will have orifice control.

FIG. 2 shows the circulatory nature of the water flow in the hydraulic solid transportation system. Water from the black water reservoir in FIG. 1 is recycled and primed so that it flows through the high range pump 440 and can be pumped into the down pipe ready to purge the coal from the pressure hoppers in the system.

It should be noted that the recycled water is unlikely to be 100% pure and thus any recycled water entering the down pipe may have a low density suspension of coal or other particulates. Alternatively however, multiple filtration and distillation systems may be introduced into the transportation system in order to purify any recycled water.

The incremental pipe and frame section 410 and pipe system anchorage 420 is herein shown in FIG. 2. An incremental frame section is advantageous for the manufacture and positioning of a hydraulic solid transportation system and also allows for an adjustment in the height of the said hydraulic solid transportation systems in accordance with the height and depth of a mine shaft, however alternatively, the piping system may be manufactured as one whole welded piece, or a combination of piping frame work. FIG. 2 also highlights a throttle valve 270 and 280 located substantially towards the bottom of the down pipe and the bottom of the up pipe. The throttle valves 270 and 280 can increase or decrease the pressure in either the up pipe or the down pipe. An increase of pressure in the down pipe by adjustment of a throttle valve will have an effect on the pump power of the cross pipes 250, as this will increase the surge of pressure through the cross pipes from the down pipe to the up pipe, thus in turn will increase the flow rate in the up pipe. An increase in the flow rate in the up pipe will invariably increase the productivity of the transportation of coal from the coal mine shaft to the surface.

Primer 450 is a general mechanism which may be used in the system in order to prepare the water so that it is at a suitable grade to be recycled in the hydraulic solid transportation system.

Both up-pipe and down-pipe may be fully drained to sump 490 or a holding tank and pump. This will enable an emergency drainage of the whole hydraulics solid transportation system.

A secondary diesel powered back-up pump 470 is shown to be used in the event of a high range pump 440.

Once the particulate-fluid suspension reaches the exit of the up pipe, the slurry is transported to a dewater and preparation system 460 for separation of the crude coal from the slurry.

FIG. 2A shows the shaft wall 1510 to which the cradle will secure the piping system to by means of heavy bolting. The cradle framework 1500 will then be secured at incremental lengths down the length of the vertical piping to which the heavy side bolting will be secured into the mine shaft wall with the support of the spine girder (as shown in FIG. 4). Although a cradle and securing means for the hydraulic solid transportation system has been disclosed, alternative methods and variations may be used to secure the system. FIG. 2A also gives an indication of the space a hydraulic solid transportation system would take up in relation to the circumference of a skip rope winder system 1520. The present invention is likely to use minimal space in a mine shaft compared to existing systems to transport coal.

FIG. 3 shows a vortex scour injection system 500. Vortex scour injection system 500 may be used in an embodiment of the invention to purge the pressure hoppers of coal up the up pipe. As well as pumping water through the jets of the vortex scour injection system, the vortex scour injection system also comprises a vortex inducing means which will create a vortex within the pressure hopper which will substantially increase the rate of purging of the coal-water slurry from the pressure hopper. Once the coal-water slurry has been purged from the pressure hopper, the remaining water will be drained. After drainage, more coal particulates are fed into the receiver pressure hopper via the screw conveyor. At this point the receiver pressure hopper will be under a fluid lock (similar to an airlock) by the closing of the hopper to the hydraulic system by the closure of valves 520. Once the pressure hopper is filled with coal particulates, the valves 520 are re-opened and the vortex scour injection system acts to purge the pressure hopper of coal particulates and direct the coal particulates in a coal-water slurry suspension up the up pipe. The cycle is then restarted.

FIG. 4 shows a zoomed in version of the incremental pipes 600 and furthermore, shows heavy side bolting 620 in which the piping system will be bolted to the mine walls. Preferably, a spine girder 630 will be attached in between the down pipe 640 and up pipe in order to stabilize the framework of the hydraulic solid transportation system. In a preferred embodiment, the piping frame work may be manufactured to approximately 10 metre incremental lengths that each incremental section can be slotted into one an other in order to achieve a relevant height of the piping frame work in accordance with the depth of the mine shaft. The up pipe and down pipe preferably is linked by a cross-pipe 6110 at every incremental length.

FIG. 4A shows a birds eye view of the cradle installation means. A securing framework 1610 will secure the piping framework 1630 to the mine shaft wall 1640 by means of tell-tale bolts 1600 the cradle structure will be stabilized by means of a spine girder which will run through the middle of the piping framework in between the up pipe and down pipe of a hydraulic solid transportation system.

FIG. 5 shows a preferred embodiment of the present invention whereby incremental piping length structures 700 of approximately 30 foot whereby a plurality of incremental piping structures can be linked together by means of hook and eye securing means or hook and bolt securing means 740. FIG. 5 also shows a cross piping structure 710 connecting the up pipe and down pipe. FIG. 5 also shows a control valve 750 for controlling the flow rate and pressure of any fluids or particulates crossing between the down pipe and up pipe. There is also shown a vortex inducing means 730 located on cross pipe 710 for inducing a vortex in fluids passing along the up pipe.

FIG. 6 shows a dual pressure hopper with a breather and breather valve 810 and 820 located on a first hopper 910 and second hopper 920 as a preferred embodiment of the present invention. In a preferred embodiment of the invention, a dual hopper system is used to expedite the cycle time. After hopper 910 has been purged of coal particulates by vortex scouring injector 930 and transported to up pipe 860 via hopper exit 950, so that coal can not flow up the up pipe 860, hopper 910 is fluid locked. Whilst hopper 910 is being purged, hopper 920 can be filled with coal particulates via screw conveyor 840. Fluid can not be transferred from hopper 910 to hopper 920 at this stage as regulator valves 870, 880 and 890 are all closed. Once both hopper 910 has been purged and hopper 920 has been filled, regulator valves 880 and 890 are both opened so that fluid can be transferred from hopper 910 to hopper 920 in order to purge coal particulates from hopper 2 using the vortex scour injector to pump the particulates up the up pipe 860 via hopper exit 960. Regulator valve 890 is then closed and coal particulates can then be filled up in to hopper 910 via the screw conveyor 840 and the cycle restarted.

A dual system is preferred however only one hopper maybe used or a number of hoppers in order to increase or decrease cycle time. A flow regulator bypass 900 may also be located to connect down pipe and up pipe as a bypass of the pressure hopper system. The control of the liquid flow through flow regulated bypass 900 is controlled via regulator valve 870. A flow regulated bypass system may be introduced in order to control water flow around the hydraulic solid transportation system in the event that water pressure is decreased during the filling or purging of the hopper or dual pressure hopper system.

Wherein a preferred embodiment there are at least two pressure hoppers in the system, all pressure hoppers are sealed using locking valve. Hopper 910 will be filled with water and then sealed by said locking valve. Coal particulates are then transported into hopper 910 from either screw feeder 830 or a slurry pump (not showing) simultaneously, regulator valves 870, 880 and 890 are then opened such that water is purged in to hopper 902 at a rate higher than that of the coal input. Such a system will create a suction in hopper 910 enhancing the filling of coal particulates from the screw conveyor 840 or slurry pump therefore increasing the efficiency of filling hopper 910 with coal particulates.

At this stage, hopper 920 will now be full with the drained water ready to be filled with coal from screw conveyor 840 or a slurry pump (not shown). Hopper 910 will also be purged of all trapped air by the purging of air through breather valve 810. Following this, and closure of regulator valves 870, 880 and 890 coal particulates can then be injected up the up-pipe 860 by a hopper exit 950.

It is important to increase the efficiency of the hopper section of the system that maximum reduction of air in the hopper is created. Therefore, the fluid must be de-oxygenated as far as possible by stagnant surface tanks. The reduction of any air or microbubbles in the hoppers 910 and/or 920 also reduces the risk of the build up of air pressure. Such air and air microbubbles maybe charged with energy relative to the pressure where the volume is 18 cu ft full of air and approximately 500 psi pressure containing 2 million ft/lb of energy.

If the air/gas micro-bubbles can be compressed, the time required for air exhaustion is reduced.

The pressure hoppers will preferably be constructed of steel or other suitable material suitable to withstand the pressures and temperatures of the hydraulic transportation system.

FIG. 7 shows a preferred embodiment of current invention where at least one of the hoppers is inclined 1000 such that the hopper is at a gradient so that fluid and or a coal-water slurry will move by gravity towards the entrance to the up pipe. As per FIG. 7, a preferred embodiment of the present invention may be that the vortex scour injector system 1090 is located substantially towards the bottom of the said inclined flush hopper 1000. There is also located on the inclined flush hopper a breather and a breather valve 1010. In a preferred embodiment of the invention, valves 1080 may be adjusted in size of the orifice in order to increase or decrease the pressure of the fluid flushing in to the inclined hopper via the scour jets 1070. This will in turn control the rate at which coal is purged up the up pipe 1120 and out of the system. Breather and breather valve 1010 is located in order to release or increase the pressure in the inclined flush hopper in accordance with the hydraulic solid transportation system requirements. Via the breather and breather valve, air pressure water vapour may also be used in order to purge coal particulates from the hopper in to the up pipe. Fluid may then be injected via the vortex scour injector system in order to purge the air out and create a continuous hydraulic flow in order to pump the coal particulates up the up pipe.

Located substantially towards the bottom of the hopper is a drain 1100 with an open and close valve 1110. This will allow for water to be drained out of the hopper and to an emergency sump 1060 as a safety precaution. Valve 1050 is located on the down flow pipe 1040 at a height lower than that of the connector to the vortex fluid supply system of which when valve 1050 is opened, water may be released in an emergency to the sump 1060. Valve 1030 controls the intake of coal particulates into the hopper via screw conveyor 1020.

FIG. 8 shows a preferred embodiment of the present invention comprising a dual pressure hoppers 1200. Located on the dual pressure hoppers are breathers and breather valves 1290 and 1300. The breather valves when opened can allow air or water vapour into the hoppers in order to increase the pressure thus increasing the rate of purging of coal particulates from the hopper to the up pipe 1260. The breather valves may also be opened in order to release pressure from the hopper when the pressure in the system is at hazardous levels.

FIG. 8 also shows multi-section construction elements 1250 to the dual pressure hoppers. In a preferred embodiment of the present invention, the dual pressure hoppers may be constructed in sections and welded or bolted together in a substantially water and air tight manner to form a complete pressure hopper. However, alternatively, the dual pressure hoppers may be molded and installed as a single unit.

FIG. 8 also shows a two way valve 1210 located on the vortex scouring system 1220 and 1230 at a position of the piping network 1240 which links the first dual pressure hopper with the second dual pressure hopper. The two way valve 1210 allows for fluids to be transferred between first dual pressure hopper and second dual pressure hopper.

The use of a dual pressure hopper system is advantageous to maintain a continuity of coal particulates supply to the up pipe. As one dual pressure hopper is being purged of coal particulates in a coal transportation cycle, the other hopper is being filled with coal particulates. Furthermore, the drainage of water from the purged pressure hopper, to the hopper which is filled with coal particulates, reduces water loss and reduces the cycle time as the drained water can be used to purge the hopper with coal particulates. In a preferred embodiment, one hopper is always in cyclic opposition to the secondary hopper in order to maximize coal particulate transportation output.

Closure of control valves 1310, 1320 and regulator valves 1270 can allow for a pressure hopper or combination of pressure hoppers to be fluid locked.

FIG. 9 shows a graph showing the speed of water flow in the up pipe in miles per hour in proportion to the percentage coal output in million tonnes per annum. It can be seen clearly that the increase in flow rate of the system will proportionately increase the output of coal particulates.

The change in flow rate can be adjusted by an increase or decrease in orifice size of the cross pipe valves, the vortex scour injection control valves or any of the regulator valves which are located on the up pipe, down pipe or dual pressure hoppers.

As mentioned previously, problems may occur in this system whereby there is a blockage in the up pipe or there is a fall back problem with regards to large dense particulates which are too heavy to counteract the pull of gravity. In order to combat this problem, cross pipes with vortex inducers and pumping means can be used to increase the energy pushing coal particulates up the up pipe.

However, there is also a need to monitor the source of where this problem is in the system so that a particular valve located near the source of the problem can be altered.

It is preferential that one or a combination of valves may be altered at any one time in order to maximize energy efficiency without having to alter every valve in the system when there is only a small local problem. Therefore, in a preferred embodiment of the present invention, an automated or semi-automated monitoring device disclosed so that areas of distress in the system can be instantly corrected by a combination of valve corrections controlled by a control centre. The control centre is designed and calibrated to respond with the correct force and timing of force, to correct the transportation system to the required flow pattern. All valves and monitors will be placed suitably to continuously monitor and to correct the systems to suit the changing demands in order to produce an efficient transportation of coal particulates.

Therefore, a control monitor system will minimize the amount of water or fluid used compared with the weight of solid particulates raised up the up pipe.

A Doppler type monitoring system may be used. A Doppler system is a navigational aid which operates at a high frequency and utilizes a wide aperture radiation system to reduce errors caused by reflection from terrain or other obstacles. Specifically, a Doppler ultrasonic flow meter may be used at various points on the up pipe, down pipe, or dual pressure hoppers as an instrument for determining the velocity of fluid flow from the Doppler shift of high frequency sound waves reflected from particles or discontinuities in the flowing fluid. Therefore a Doppler ultrasonic flow meter monitoring system may be able to detect a change in the normal flow rate and therefore activate an automated control of the pump pressure and valve position at certain points in the hydraulic solids transportation system. Any anomaly detected by the flow rate monitor would cause an automated response by the system via an adjustment in valves or pump pressure in order to stabilize the flow rate at the place of distress. Although it is preferred that the monitoring system is automated, it may be the case that monitoring system is manually operated.

In order to provide for a monitoring system which is able to auto-correct, the measurement at normal flow rate must be carefully calibrated in order to create a memory of normal operating modes so that any monitoring system is able to then predict possible stress or potential failure of equipment so that the hydraulic solid transportation system can self right to its normal mode of operation.

An alternative method of monitoring the flow rate and suspension density of the coal-water slurry in the hydraulic solid transportations system would be to install water proof CCTV cameras at a plurality of points on the inner walls of the piping frame work so that the flow of the coal-water slurry could be monitored from a central location via television monitors. Workers who are monitoring the CCTV cameras would be able to get a visual monitor of a certain part of the transportation system and thus could react to abnormalities, for example fall back or blockage, by the adjustment of pump output or valve position.

In a preferred embodiment, a breather pipe may be located at one or various locations on the hydraulic solid transportation system with a valve control as an emergency facility to allow possible investigative access of the internal conditions of the system by CCTV or other audio visual devices. Investigations could be carried out during periodic maintenance cycles.

A relatively low power requirement is required for raising coal up the up-pipe 230 in its normal operation and the water pumps up the up-pipe to 30 can be configured to directly match the volume of coal raised i.e:

Power used=(tons of coal raised−tons of water pumped)×time

The power reduction per ton of coal raised to the mineshaft's surface compared to conventional methods as disclosed in the prior art coupled with use of hydraulic pressure to work the system, further provides an environmentally friendly and efficient system.

The hydraulic solid transportation system may have a multiple of high performance pumps. Some of the pumps may be used as a backup in the event of power loss of one system or mechanical failure.

FIG. 10 shows a birds eye view of a cradle construction 1400 for the installation of the hydraulic solid transportation system. The piping frame work 1460 of the hydraulic transportation system must be installed with great accuracy and provision and suitably secured in order to respond and deal with the variation of shocks and stresses associated with the use of substantial power applications at a plurality of points long and within the system.

The cradle is a frame work or other supporting means which may be used for the supporting or restraining of objects. In a preferred embodiment of the present invention, the piping framework system will be lowered down into the mine shaft in sections or as a whole using a laser guidance tool in order to lower the system into the exact correct positioning. Monitor lines 1420 and cable 1430 will be used to restrain the piping network and the system will be secured to the cradle. Tell tale bolts on 1410 will be used to secure the cradle and attach the piping system at the surface of the mine shaft.

To assist the suppression of dust, dry air and combustible coal particles to reduce the combustibility on the conveying means, an alternative embodiment may allow for clean hydrant water from the hydraulics solid transportation system to be used to be sprayed in the form of water vapor within the vicinity of the conveying means in order to suppress the combustibility of dust, dry air and coal particles.

It should also be noted that safety requirements required by differing national law and regulation can be readily implemented or the system altered in order to comply with said national laws and regulations.

Although valves, regulator valves and control valves have been mentioned, alternative valves may be used including but not limited to stop valves, one way valves, two way valves, and multi-directional valves.

It should be borne in the mind of the person skilled in the art that the system will comply with all regulations and industry standards. The solid hydraulic transportation system is ideally designed to transport a suspension in a fluid. During operation of the solid hydraulic transportation system, particular care will be taken to the systematic examination and repair throughout the lifetime of its operation. This may include installation calibration at the start and during operation as well as safe dismantling at the finish.

It is possible that the preferred embodiment may be utilized to hydraulically raise various solids and/or fluids and carrying mass and differing particle size and shape.

Referring to FIG. 11 herein, once the coal water slurry has been pumped up the up pipe 1500, in a preferred embodiment of the present invention coal water slurry is directed into a solid de-water reduction chamber 1530 in order to be separated. Preferably, a solid de-water reduction chamber has a shape and curvature which substantially matches the trajectory of the coal water slurry being pumped out of up pipe 1500. Out of the arc of the de-water reduction chamber 1530, coal water slurry is separated by means of water being sucked up the cyclone and re-circulation exit points 1520 via filtration through sieve plates 1540 into sieved fluid chamber 1550 and up expresser pipes 1510. The sieved plate contains pores which allow water to pass through the sieve plate membrane however, the pores are not large enough to allow coal particulate to cross the sieve plate membrane. The separated coal/solid particulate continue to travel by gravity down the solid de-water reduction chamber and exit the chamber via solid particulate un-loader 1560.

The de-water chamber 1530 is preferably inclined such that the heavy coal particulates will fall to the bottom of chamber 1530 to allow for partial separation to occur by gravity. The heavy coal particulates will then be removed from the system via the solid particulate un-loader 1560.

Referring to FIG. 12, 1640 shows the directional flow of the coal water slurry being pumped up the up pipe into the solid de-water reduction chamber. A preferred embodiment of the present invention, de-blinding jets will be located in the solid de-water reduction chamber directed towards the surface of the sieve plate. After extensive use of the system, the sieve plate may become blocked due to coal particulate deposit blocking the pores therefore slowing down the filtration of water through the sieve plate into a sieved fluid chamber. The de-blinding jets 1600 act to direct high pressure water to the sieve plate in order to clean the sieve plate surface and therefore act as a cleaning mechanism to allow continuous efficient filtration and separation of the coal water slurry. In a preferred embodiment all expresser pipes 1510 are linked via a transportation pipe 1610 allowing for removal of water from the de-water reduction chamber. De-water chamber cross section 1620 and 1630 show a close up view of a section of a sieve plate and expresser pipe, with and without the presence of de-blinding jets 1600.

De-binding jets 1600 also inject water into the de-water chamber 1530 which is advantageous in order to aide the dilution of the solid particulates. De-binding jets 1600 are further advantageous to replenish water lost from expresser pipes 1510.

The sieve plate is preferably made from wedge wire, however any other known porous material may be used.

Referring to FIGS. 13 and 14 herein, a zoomed in view of solid particulate un-loader 1560 is shown. The separate coal particulates become separated from water via the sieve plates, flow directionally 1710 to the exit of solid de-water reduction chamber 1800. In a normal method of operation, the removal of coal particulates to a collection means is controlled via solid particulate un-loader 1560. Solid particulate un-loader 1560 comprises a rotating drum 1810 a rotating drum valve 1820 a seal 1830 and rotating drum axle 1700. Once solid particulates collect at the top of the rotating drum axle 1700, the weight of the solid coal particulate pushes the valve in a clockwise or anti-clockwise direction by gravity force. When this section of the solid particulate un-loader is in-line with solid particulate exit points 1730 coal particulates are removed from the system. The solid particulate un-loader is configured to move only when the weight of the coal/solid particulates reaches a certain weight. In the event of an overflow towards the exit of the solid de-water reduction chamber, or in the event that there is a malfunction in the operation of the solid particulate un-loader, escape hatch 1840 can be opened to allow for rapid removal of solid particulates from the solid de-water reduction chamber. Preferably, the solid particulate un-loader is configured to be a drum 1720.

Referring to FIG. 15, a sectional view of up pipe 1900 and down pipe 1910 is shown with a section of the support frame work 1970 which acts as a scaffold to stabilize the structure of the system. In a preferred embodiment of the present invention, a high pressure low volume jet of water can be directed to up pipe 1900, from a high pressure pipe 1920 which runs parallel to up pipe 1900 and is linked incrementally by at least one cross pipe 1930. The high pressure pipe 1920 will be used when an increase in pressure was required at a certain point in up pipe 1900 in the event of a drop in water pressure or blockage in the up pipe. The energy or water pressure that could be supplied by high pressure pipe 1920 via cross pipe 1930, would be in addition to the cross pipes 1940 which link down pipe 1910 to up pipe 1900. Use of high pressure pipe 1920 would mean that the cross pipes 1940 would not need to be opened as regularly to increase the pressure in up pipe 1900 therefore allowing for a maintenance of pressure in down pipe 1910. In a preferred embodiment, all cross pipes would be operated by automated valves 1960 as well as failsafe manual valves 1950.

Referring to FIG. 16, the filtration and separation method of the coal water slurry may be incrementally carried out by using a series of sieve plates 2020. The coal water slurry that is separated could be purified further in stages in order to recover as much coal as possible from the system. A clean water supply 2000 is used to supply water de-blinding jets 2010, which in turn will clean the sieve plate surfaces in order to maintain clear pores. The de-blinding jets can be manually or automatically operated to de-blind the sieve plates at regulated time intervals. The coal water slurry would move through a first sieve plate and up a connector pipe 2030 which would then be connected to the next sieved fluid chamber 1550 and then passed through an additional sieve plate. This could be continued dependent on the purity requirement of the system and the separated water eventually removed from the system via expresser pipe 2040.

An air/gas purge apparatus as shown in FIG. 17 is preferably connected to breather pipe 2260 for the purging of air/gas bubbles in the water stored in slide bunker 2200.

Referring to FIG. 17 herein, there is shown an operation to allow for expulsion of air/gas from the hopper injectors 2100 of the transportation system therefore allowing for the solid particulates to be transported under a vacuum, in turn increasing the pressure and therefore efficiency of the transportation of the solid particulates up the up pipe entrance 2180.

The prevention of air gases entering the rising solids/water column (up pipe entrance 2180) is most preferred as any air trapped in solids or aerated water can expand as it rises through the pipes within the system. This can cause areas of non-contact with the said particulates, resulting in fall back as the expanding bubbles accelerated to the surface, severing motive interface with the solid particulates.

An air/gas purging system as shown in FIG. 17 has been designed to induce a lower pressure (down to vacuum conditions) in the system in order to suck or purge air from the pressure hopper injector 2100.

Once the pressure hopper injector is fully filled with coal and water, all valves are closed to balance the supply pressure. Breather valve 2120 is opened and a quantity of water pumped out of receiver tank 2140 thereby inducing low pressure suction of the coal/water slurry towards a solution to the purge line 2130 causing air to be expelled along the purge line 2130 from the hopper injector 2100 to replace the water being purged from the receiver tank 2140 via operation of the suction 2160 pump liquid from the receiver tank 2140 is directed to a holding tank 2190 for recycling or removal from the hydraulic solid transportation system. The breather valve 2120 is closed when no further air/gas is required to be removed from the hopper injector 2100.

This process may be repeated until no air/gas remains within the pressure hopper 2100 injector.

The air/gas which is purged from the hopper injector 2100 may contain flammable gases. Such gases may be released to the atmosphere through a suitable diffuser 2150 allowing for safe removal. The air/gas would be replaced slowly by re-filling the receiver tank 2140 with liquid when the breather valve 2120 is closed, therefore allowing for slow pressurized release of gas/air into the atmosphere via the diffuser 2150.

Any void caused by the purging of air/gas from the hopper injector is remediated by flushing of the injector 2100 by the late closure of the breather valve 2120. Liquid lost from the hopper injector 2100 maybe replenished by injection of liquid from injector jets 2110.

For the system for expelling air/gas to operate, the purge line 2130 must be filled with water i.e. the system must be sealed. If the purge line is not completely or substantially full of liquid, the suction pump will have limited functionality reducing efficiency. The purge line 2130 being filled with water allows for the suction pump 2160 to operate under negative pressure.

Suction pump 2160 can also be reversed to act as a water pump to pump water into the hopper injector 2100 to ensure purge line 2130 is free of air, prior to diffusion of air/gas trapped in the hopper injection 2100.

Referring to FIG. 18 herein, in a preferred embodiment there is present an inclined low pressure slide bunker (hopper) 2200.

The circular inclined low pressure lateral storage “slide” bunker 2200 is larger than a pressure hopper injector 2100 but operates at a much lower pressure. The “slide” bunker 2200 may be constructed to produce continuous supply of water to the bunker from the slide hopper water jets 2200 and hopper water supply 2250.

The operation is not necessarily in sync with injection operations other than filling from the delivery end. “Bunker” filling of solid particulates from the solid particulate input 2210 (supply sizers and mixers) may take place at any time. The solid particulates are moistened on input creating a sluice or water channel which travels along the bunker 2200. The particulates are moistened by water inputted by water jets 2200, which the sluice will form the shape of a screw effect on the coal/water slurry along the internal surface of the bunker. Different raw coal inputs may vary, concerning the percentage of coal mix as the coal/rock particulate proportions vary to account for and short fall of water in the event of a leak, or a drop in pressure resulting in a shortage in water supply to the system.

Referring to FIG. 19 herein, an overview of the hydraulic transportation system can be seen. The stop or isolation valve may be present every 300 meters in order to act as a safety mechanism to close of the system in the event of a failure of part of the system. The stop-isolation valves may be annually or automatically operated separately or concurrently. Further, the stop or isolation valves may be remotely operated. FIG. 19 refers to a dual pressure hopper system comprising a first pressure hopper and a second pressure hopper. However, the system may be replaced or used in conjunction with a low pressure inclined slide hopper as shown in FIG. 18. The high pressure low volume punch injectors linking the high pressure pipe to the up pipe may be used to prevent cavitation, claying and fall back by gravity of the solid particulates and also discourage particulates streamlining. According to a preferred embodiment as shown in with FIG. 19, the main pump will be backed up by back-up pumps with the addition of the high pressure pump and hydraulic pump when a greater energy source is required. The filtration sieve is located next to the exit of the up pipe used to separate the coal from the coal water slurry. There may also be the addition of cyclones (not shown) in order to further separate and purify the coal from the coal water slurry. Cross pipe injectors and high pressure volume punch injectors may be inclined or declined towards the up pipe dependent on the operation required to be carried out. The hydraulics for the transportation system may be powered by a generator or by an oil gas/electrical power supply.

Referring to FIG. 20 herein, an embodiment the hydraulic solid transportation system may also comprise a method of periodically cleaning the whole of the up pipe 2700 and or down pipe (not shown). A high pressure hose winder 2780 and haul rope winder 2800 will lower a jet tank 2720 linked to a heavy weight 2780 vertically down an end of the up pipe 2700 and/or down pipe. Clean water will be pumped through the hose winder 2780 into the jet tank 2720. High pressure jets located at the jet tank will then direct high pressure water to the internal walls of the up pipe and/or down pipe therefore cleaning the scaling solid particulates 2790 which have accrued on the internal walls. The cleaning apparatus will be stabilized by spring loaded central stabilizer 2810. The cleaning apparatus can be wound and unwound to reach the required height for a specific area of the internal walls of the up pipe and or down pipe to be cleaned. The cleaning apparatus acts as a descaling means and therefore will prevent the blockage of the up pipe and/or down pipe.

Referring to FIG. 21 herein, the bird's eye view of a preferred embodiment can be seen. A clear indication can be seen from FIG. 21 showing the difference in mine shaft cavity coverage that the up pipe 3050 and down pipe 3060 cover in relation to the known prior art of a generic skip or cage winder solid particulate transportation mechanism 3090/3100. The up pipe and down pipe sit close to the mine shaft cavity wall located alongside the auxiliary power generator 3110. The pumps 3000, 3010, 3020, 3030, 3210 and solid de-water reduction chamber 3140 are all located towards the surface of a mine shaft. The locality provides the advantage in that the hydraulic solid transportation system can be substantially operated from the surface of a mine shaft without having to provide for an extensive human work force within the mine shaft, which would reduce safety implications.

Referring to FIG. 22 herein, the hydraulic transportation system may be controlled and monitored by close circuit TV systems (CCTV), microphone control (3020) as well as a remote control box. The hydraulic pump, compressed air source, power cables and high pressure pumps preferably located substantially at the surface of the mine shaft. Up pipe 3200 and down pipe 3210 linked by the cross pipe 3290 are located towards the edge of the mine shaft 3280 so that they can be securely fixed to the edge of the mine shaft by a framework of scaffolding (not shown).

In an embodiment of the present invention, the size of the solid particulates entering the system may be increased to 3 inches/75 mm. A size increase may assist the flow and prevent “claying” (creating a sludge which may block/clog the system). The storage bunker acts as a buffer between conveyor/sizer delivery of solid particulates and shaft stability. Multiple bunkers 2240 may be used such that they can be simultaneously or individually de-clogged. The incline of the hoppers should not be more than 2°30S net of site dip/rise.

The storage bunkers may be incrementally installed for ease and flexibility.

1. A hydraulic solid transportation system suitable for the transportation of solid particulates from a mine, said system comprising:
at least one hopper suitable for forming a fluid—solid particulate suspension in said hopper;
a down pipe for transporting a fluid to said at least one hopper;
a pump for pumping fluid down said down pipe;
an up pipe for transporting said fluid—solid particulate suspension away from said at least one hopper;
characterised by:
a plurality of cross pipes, each extending between said down pipe and said up pipe, said plurality of cross pipes being positioned at a plurality of different heights; and wherein
a fluid pressure change may be induced in said up pipe at one or a plurality of different heights in said up pipe by transfer of pressure and/or fluid from said down pipe to said up pipe via one or more of said plurality of cross pipes.

2. A hydraulic solid transportation system as claimed in claim 1, wherein said at least one hopper is a pressure hopper.

3. A hydraulic solid transportation system as claimed in any one of the preceding claims, further comprising a particulate conveying means for transporting particulates to said at least one hopper.

4. A hydraulic solid transportation system as claimed in claim 3. wherein said particulate conveying means is a screw conveyor.

5. A hydraulic solid transportation system as claimed in any one of the preceding claims, further comprising a separation chamber for separation, of said fluid-particulate suspension.

6. A hydraulic solid transporation system as claimed in any one of the preceding claims, further comprising at least one inclined low pressure slide hopper.

7. A hydraulic solid transportation system as claimed in any one of the preceding claims, wherein at least one throttle valve is located on said up pipe.

8. A hydraulic solid transportation system as claimed in any one of the preceding claims wherein at least one throttle valve is located on said down pipe.

9. A hydraulic solid transportation system as claimed in any one of the preceding claims wherein the flow across a said cross pipe, of fluid, or said particulate-fluid suspension is controlled by a control valve.

10. A hydraulic solid transportation system as claimed in any one Of the preceding claims wherein a vortex inducing means is located on at least one cross pipe.

11. A hydraulic solid transportation system as claimed in any one of the preceding claims comprising at least one secondary back-up pump.

12. A hydraulic solid transportation system as claimed in any one of the preceding claims wherein said fluid Is injected into said at least one pressure hopper by at least one vortex scour injector.

13. A hydraulic solid transportation system as claimed claim 12, wherein said at least one vortex scour injector is controlled by at least one control valve.

14. A hydraulic solid transportation system as claimed in claim 12 or 13, wherein the vortex scour injector has a vortex inducer to induce a vortex in said at least one hopper.

15. A hydraulic solid transportation system as claimed in any one of the preceding claims wherein said at least one hopper is an inclined pressure hopper.

16. A hydraulic solid transportation system as claimed in any of the preceding claims wherein said at least one hopper comprises at least two dual pressure hoppers wherein whilst a first pressure hopper is purged of particulates by an injection of said fluid, a second pressure hopper is filled by particulates via a conveying means.

17. A hydraulic solid transportation system as claimed in claim 16, wherein once said hopper has been purged of particulates by an injection of said fluid, the fluid in said first pressure hopper can be transferred to the said second pressure hopper by injection in order to purge particulates from the said second pressure hopper.

18. A hydraulic solid transportation system as claimed in any one of the preceding claims wherein said at least one hopper can be fluid locked from the system by the control of at least one control valve.

19. A hydraulic solid transportation system as claimed in any one of the preceding claims wherein the fluid used in the system can be recycled.

20. A hydraulic solid transportation system as claimed in any one of the preceding claims wherein said at least one hopper comprises at least one breather valve.

21. A hydraulic solid transportation system as claimed in any one of the preceding claims wherein a two stage cyclone system is located towards the exit of the said up pipe.

22. A hydraulic solid transportation system as claimed in any one of the preceding claims further comprising a solid particulate-fluid separation apparatus wherein said separation apparatus comprises:
a de-water chamber;
is a sieve plate;
a sieved fluid chamber; and
a solid particulate unloader.

23. A method of transporting solid particulates from a mine, said method comprising:
delivering a pressurized fluid to a hopper via a down pipe;
forming a fluid—solid particulate suspension in said hopper; and
transporting said fluid/solid particular suspension away from said hopper by an up pipe, and characterized by
creating a fluid pressure change m said up pipe at one or a plurality of different heights along said up pipe, by transferred pressure and/or fluid from said down pipe to said up pipe via a plurality of cross pipes positioned at a plurality of different heights along said up pipe.

24. The method as claimed in claim 23, wherein said fluid is injected into at least one hopper by at least one vortex scour injector.

25. The method as claimed claim 24, wherein said at least one vortex scour injector is controlled by at least one control valve.

26. The method as claimed in claim 23, 24 or 25 wherein said at least one hopper comprises at least two dual pressure hoppers wherein whilst a first pressure hopper is purged of particulates by an injection of said fluid, a second pressure hopper is filled by particulates via a conveying means.

27. The method as claimed in claim 26, wherein once said at least one hopper has been purged of particulates by an injection of said fluid, the fluid in said first pressure hopper can be transferred to the said second pressure hopper by injection in order to purge particulates from the said second pressure hopper.
